(19) United States
(12) Patent Application Publication
(10) Pub. No.: US 2015/0165541 A1
(43) Pub. Date: Jun. 18, 2015

(54) METHOD FOR TUNGSTEN INERT GAS WELDING OR PLASMA WELDING

(71) Applicant: Thomas Ammann, Kriens (CH)

(72) Inventor: Thomas Ammann, Kriens (CH)

(21) Appl. No.: 14/571,491

(22) Filed: Dec. 16, 2014

(30) Foreign Application Priority Data
Dec. 17, 2013 (DE) 102013021480.7

(51) Int. Cl. B23K 9/167; B23K 35/38

(52) U.S. Cl. CPC B23K 9/167; B23K 35/383

(57) ABSTRACT

A method and gas mixture of argon, nitrogen and carbon dioxide for tungsten inert gas welding or plasma welding is described wherein the gas mixture is a protective gas for tungsten inert gas welding or an outer gas for plasma welding. The method is particularly useful for welding stainless steels and/or duplex steels.

### CROSS REFERENCE TO RELATED APPLICATIONS

This application claims priority from German Patent Application DE102013021480.7 filed Dec. 17, 2013.

### BACKGROUND OF THE INVENTION

The invention relates to a method for tungsten inert gas welding or plasma welding, as well as to a gas mixture as a protective gas for tungsten inert welding or an outer gas for plasma welding, in particular for welding stainless steels and/or duplex steels.

During the tungsten inert gas welding (TIG welding) of stainless steels of all types (in particular duplex steels), (black or dark) contaminants, suspensions or spots can appear on the welded seam. In addition, such contaminants, suspensions or spots can also be encountered when plasma welding these types of materials. These suspensions presumably involve calcium-rich deposits from the parent metal (calcium frequently accompanies iron, and is often used as an alloying element). It has thus far been virtually impossible to influence or prevent these suspensions, which must removed from the welded seam after the fact in a complicated and expensive process, in particular when stringent requirements are placed on seam quality.

Therefore, it is desirable to provide a way to avoid the appearance of such contaminants or suspensions or spots on the welded seam while welding, in particular tungsten inert gas welding or plasma welding, stainless steels or duplex steels.

### SUMMARY OF THE INVENTION

This objective is achieved by a method for tungsten inert gas welding or plasma welding, a gas mixture as the protective gas for tungsten inert gas welding or as the outer gas for plasma welding, and a use of this gas mixture having the features in the independent claims. In particular, the invention involves welding stainless steels and/or duplex steels via tungsten inert gas welding or plasma welding. The inventive gas mixture or inventive protective gas mixture here contains argon, nitrogen and CO₂.

Standard EN 10088-1:2005 defines a stainless steel as having more than 10.5 percent chromium, which is dissolved in an austenitic or ferritic mixed crystal. Ferrite here denotes a body-centered cubic lattice structure or phase. Austenite is a face-centered cubic lattice structure or phase.

Standard DIN-EN 10088 T1 to T3 ranks duplex steels among the rust- and acid-resistant steels. Duplex steels are two-phase steels with a ferrite phase that envelops islands comprised of austenite phases. Duplex steels are characterized by their combination of properties, which combine the properties of stainless chromium steels and rustproof chromium-nickel steels. Duplex steels here exhibit higher strengths than stainless chromium-nickel steel, but also have a higher ductility than stainless chromium steel.

At least two independent gases or gas mixtures are required for plasma welding. One would be a plasma gas or central gas, which is (at least partially) ionized. In particular argon or a gas mixture comprised of argon with percentages of hydrogen or helium is used as the plasma gas. The outer gas here acts as a protective gas, similarly to TIG welding.

Significant advantages are noted within the framework of the invention for the gas mixture consisting of argon, nitrogen and CO₂ by comparison to conventional protective gases or protective gas mixtures or outer gases. The inventive gas mixture makes it possible to prevent or at least reduce the appearance of contaminants, suspensions or spots mentioned at the outset on the welded seam while tungsten inert gas welding or plasma welding stainless steels and duplex steels. The inventive gas mixture, in particular the percentage of argon and CO₂, makes it possible to influence the direction of melt flow in the molten bath or in the weld deposit, In particular, this melt flow is influenced in such a way as to yield a flow directed inwardly relative to the melt, i.e., a flow directed from the edge of the welded seam into its interior.

This flow is here in particular part of a Marangoni convection. As a consequence, the inventive gas mixture utilizes the so-called Marangoni effect. A Marangoni convection is here a flow that arises from differences in an interfacial tension (surface tension). Temperature-induced differences in the interfacial tension here come about between various areas of the melt. The flow inside the weld deposit is here in particular directed along an interface from a location with a comparatively low interfacial tension toward a locally elevated interfacial tension. As a consequence, contaminants in the weld deposit flow in particular away from the edge of the welded seam into its interior. These contaminants are thus held in the weld deposit, and cannot be deposited onto the weld deposit or onto the welded seam, thereby eliminating or largely preventing contaminants, suspensions or spots on the welded seam.

In an advantageous embodiment of the invention, stainless steels and/or duplex steels are subjected to low-ferrite or controlled-ferrite welding. In particular, the inventive gas mixture allows low-ferrite welding. Especially in the chemical industry, specific types of stainless steels or duplex steels must be welded in such a way as to establish a specific ferrite content in this material or in the corresponding welded seam. This makes it possible to avoid corrosion in particular, For example, such stainless steels or duplex steels include materials with material numbers 1.4435, 1.4462 or 1.4501. In particular, this is the case in TIG welding, further especially in TIG orbital welding without filler metal, during which work is generally performed without filler metal, so that ferrite cannot be controlled by over-alloying nickel in the filler metal.

Nitrogen is an austenite former, and has a highly austenitizing effect. The inventive nitrogen-containing gas mixture as the protective gas or outer gas makes use of this austenitizing effect. As a consequence, the formation of ferrite or a ferrite phase in the weld deposit is suppressed. The ferrite content in the material or weld deposit can thus be set and controlled. For example, it may be expedient to control the ferrite content in the weld deposit in this way so as to safeguard corrosion resistance (for the stainless steels) or mechanical and technological properties (for the duplex steels). In addition, the inventive gas mixture prevents contaminants, suspensions or spots from arising on the welded seam in these materials as well.

Using the inventive gas mixture for low-ferrite welding in this way is especially beneficial for metastable austenites, full austenites and duplex steels. Therefore, the inventive gas mixture has the advantage on the one hand of yielding a Marangoni flow directed inwardly relative to the melt and independent of potential alloy differences (in particular owing to the percentage of CO₂), so that contaminants or suspensions or spots on the welded seam can be avoided. On the other hand, the advantage to the inventive gas mixture is that it has a ferrite-reducing effect (in particular owing to the nitrogen), so that types of stainless steel and duplex steels can be subjected to low-ferrite welding.

### DETAILED DESCRIPTION OF THE INVENTION

In a preferred embodiment of the invention, the gas mixture contains between 1% and 5% nitrogen, in particular 3%. Alternatively or additionally, the gas mixture preferably contains (essentially) between 0.3 and 0.7%, in particular 0.5% CO₂. This gas mixture is here in particular a complementary gas mixture that can expediently be varied. In particular, this gas mixture is suitable for TIC welding, and further in particular for low-ferrite TIC welding, stainless steels and/or duplex steels.

The gas mixture preferably also contains hydrogen. The gas mixture here preferably contains more than 0% and at most 10%. In particular, the gas mixture contains between 1% and 5%, further in particular 5%, hydrogen: The percentage of hydrogen makes it possible in particular to increase the welding rate. As a consequence, the efficiency or effectiveness of TIC welding can be increased.

In addition, the percentage of hydrogen protects the TIG welding electrode against oxidation by the percentage of CO₂. This reduces wear on the TIG welding electrode. This embodiment of the gas mixture with the hydrogen percentage is beneficial in particular for austenitic, stainless steels. The ferrite content of the weld deposit can here be precisely controlled and set.

Another phenomenon frequently encountered in welding practice during conventional TIG welding or conventional plasma welding has to do with insufficient or irregular root penetration given mating parts from various material batches or welded joints comprised of different types of stainless steel (e.g., pipe-on-flange joints, etc.). The varying contents of alloying constituents can result in irregular molten bath flows, which impede a constant root penetration. In particular sulfur has a great influence on the surface tension of the melt, and hence on its flow behavior. The embodiment of the gas mixture with a percentage of hydrogen makes it possible to equalize or offset these effects of varyingly directed flows in the molten bath. This equalization or compensation of batch differences combined with the avoidance of contaminants or suspensions or spots ensures a constant root penetration.

In another preferred embodiment, the gas mixture additionally contains helium, or helium is used in addition to the gas mixture as the protective gas. The gas mixture preferably contains more than 0% and at most 50% helium. In particular, the gas mixture contains between 10% and 50% helium, further in particular 25%. This gas mixture with a percentage of helium is especially suitable for welding duplex steel. The percentage of helium makes it possible to precisely control and set the ferrite content of the weld deposit or a ratio between the ferrite and austenite of the weld deposit. In addition, the percentage of helium enables the equalization or compensation of batch differences. As a consequence, the gas mixture with a percentage of helium can also be used to ensure a constant root penetration through the equalization of batch differences and avoidance of suspensions.

In addition to the method for tungsten inert gas welding or plasma welding and the gas mixture as a protective gas mixture for tungsten inert gas welding or as an outer gas for plasma welding, the invention further relates to the use of an inventive gas mixture comprised of argon, nitrogen and CO₂ as a protective gas during tungsten inert gas welding or as an outer gas during plasma welding. All aforementioned features and advantages are to apply analogously to the inventive method, the inventive gas mixture and inventive use.

What I claim is:

1. A method for tungsten inert gas welding or plasma welding, characterized in that a gas mixture comprising argon, nitrogen and CO₂ is used as the protective gas during tungsten inert gas welding, or as the outer gas during plasma welding.

2. The method according to claim 1, characterized in that the tungsten inert gas welding or plasma welding is for welding stainless steels or duplex steels.

3. The method according to claim 2, wherein stainless steels and/or duplex steels are subjected to low-ferrite welding.

4. The method according to claim 1, wherein the gas mixture contains between 1% and 5% nitrogen and between 0.3% and 0.7% CO₂.

5. The method according to claim 4, wherein the gas mixture contains 3% nitrogen.

6. The method according to claim 1, wherein the gas mixture further comprising hydrogen.

7. The method according to claim 6, wherein the gas mixture contains up to 10% hydrogen.

8. The method according to claim 7 wherein the gas mixture contains between 1% and 5% hydrogen.

9. The method according to claim 1, wherein the gas mixture further comprising helium.

10. The method according to claim 9, wherein the gas mixture contains up to 50% helium.

11. The method according to claim 10, wherein the gas mixture contains between 10% and 50% helium.

12. The method according to claim 11, wherein the gas mixture contains 25% helium.

13. A gas mixture for use as a protective gas for tungsten inert gas welding or as the outer gas for plasma welding, characterized in that the gas mixture is a mixture comprising argon, nitrogen and CO₂.

14. The gas mixture according to claim 13, characterized in that the tungsten inert gas welding or plasma welding is for welding stainless steels or duplex steels.

15. The gas mixture according to claim 13, wherein the gas mixture contains between 1% and 5% nitrogen and between 0.3% and 0.7% CO₂.

16. The gas mixture according to claim 14 wherein the gas mixture contain 3% nitrogen.

17. The gas mixture according to claim 13, wherein the gas mixture further comprising hydrogen.

18. The gas mixture according to claim 17, wherein the gas mixture contains up to 10% hydrogen.

19. The gas mixture according to claim 18 wherein the gas mixture contains between 1% and 5% hydrogen.

20. The gas mixture according to claim 13, further comprising helium.

21. The gas mixture according to claim 20, wherein the gas mixture contains up to 50% helium.

22. The gas mixture according to claim 21, wherein the gas mixture contains between 10 and 50% helium.

23. The gas mixture according to claim 22, wherein the gas mixture contains 25% helium.

24. A method of using a gas mixture comprising argon, nitrogen and CO₂ as a protective gas during tungsten inert gas welding or as an outer gas during plasma welding.

25. The method according to claim 24, characterized in that the tungsten inert gas welding or plasma welding is for welding stainless steels or duplex steels.

26. The method according to claim 24, characterized in that the gas mixture further comprises hydrogen.

27. The method according to claim 24, characterized in that the gas mixture further comprises helium.
